(19) United States
(12) Patent Application Publication
(10) Pub. No.: US 2025/0229767 A1
(43) Pub. Date: Jul. 17, 2025

(54) CONTROL DEVICE FOR HYBRID VEHICLE

(71) Applicant: TOYOTA JIDOSHA KABUSHIKI KAISHA, Toyota-shi Aichi-ken (JP)

(72) Inventor: Naoki HAYASHIMA, Toyota-shi Aichi-ken (JP)

(73) Assignee: TOYOTA JIDOSHA KABUSHIKI KAISHA, Toyota-shi Aichi-ken (JP)

(21) Appl. No.: 19/013,105

(22) Filed: Jan. 8, 2025

(30) Foreign Application Priority Data
Jan. 11, 2024 (JP) 2024-002566

(51) Int. Cl. B60W 20/40; B60W 60/00

(52) U.S. Cl. CPC B60W 20/40; B60W 60/001; B60W 2510/244; B60W 2520/10

(57) ABSTRACT

A control device includes a switching unit, a determination unit, and a setting unit. The switching unit switches a traveling mode of the hybrid vehicle to a motor traveling mode in which an engine is stopped and a motor is driven when a required value related to the motor is less than a switching value, and switches the traveling mode to a hybrid traveling mode in which the engine is driven when the required value is equal to or greater than the switching value. The determination unit determines whether a driving mode of the hybrid vehicle is an autonomous driving mode or a manual driving mode. The setting unit sets the switching value to a first value when the driving mode is the manual driving mode, and sets the switching value to a second value greater than the first value when the driving mode is the autonomous driving mode.

### CROSS-REFERENCE TO RELATED APPLICATION

This application is based upon and claims the benefit of priority of the prior Japanese Patent Application No. 2024-002566, filed on Jan. 11, 2024, the entire contents of which are incorporated herein by reference.

### TECHNICAL FIELD

The present disclosure relates to a control device for a hybrid vehicle.

### BACKGROUND

There is a hybrid vehicle in which a traveling mode is switched to a motor traveling mode or a hybrid traveling mode, and a driving mode is switched to an autonomous driving mode or a manual driving mode (see, for example, Japanese Unexamined Patent Application Publication No. 2019-034736).

The motor traveling mode is a traveling mode in which the engine is stopped and the motor is driven. Therefore, when the vehicle is in the motor traveling mode in the manual driving mode, the acceleration response might deteriorate, and the drivability might deteriorate. On the other hand, the hybrid traveling mode is a traveling mode in which the engine is driven. Therefore, when the hybrid traveling mode is selected in the autonomous driving mode, the fuel efficiency might deteriorate due to the driving of the engine.

### SUMMARY

It is therefore an object of the present disclosure to provide a control device for a hybrid vehicle which ensures drivability and improves fuel efficiency.

The above object is achieved by a control device, for a hybrid vehicle including a motor and an engine, includes: a switching unit configured to switch a traveling mode of the hybrid vehicle to a motor traveling mode in which the engine is stopped and the motor is driven when a required value related to the motor is less than a switching value, and to switch the traveling mode to a hybrid traveling mode in which the engine is driven when the required value is equal to or greater than the switching value; a determination unit configured to determine whether a driving mode of the hybrid vehicle is an autonomous driving mode or a manual driving mode; and a setting unit configured to set the switching value to a first value when the driving mode is the manual driving mode, and to set the switching value to a second value greater than the first value when the driving mode is the autonomous driving mode.

The second value may increase as a vehicle speed of the hybrid vehicle decreases.

The first value may be a fixed value that does not change depending on the vehicle speed.

The control device may further include an acquisition unit configured to acquire a charged amount of a battery that is a power source of the motor, wherein the second value may increase as the charged amount of the battery increases.

### BRIEF DESCRIPTION OF THE DRAWINGS

FIG. 1 is a schematic configuration view of a hybrid vehicle;

FIG. 2 is a flowchart illustrating an example of switching value setting control;

FIG. 3 is an exemplary view of a map defining a switching value;

FIG. 4 is a first variation of a map illustrating a switching value;

FIG. 5 is a flowchart of a variation of the switching value setting control; and

FIG. 6 is a second variation of the map illustrating the switching value.

### DETAILED DESCRIPTION

### Schematic Configuration of Hybrid Vehicle

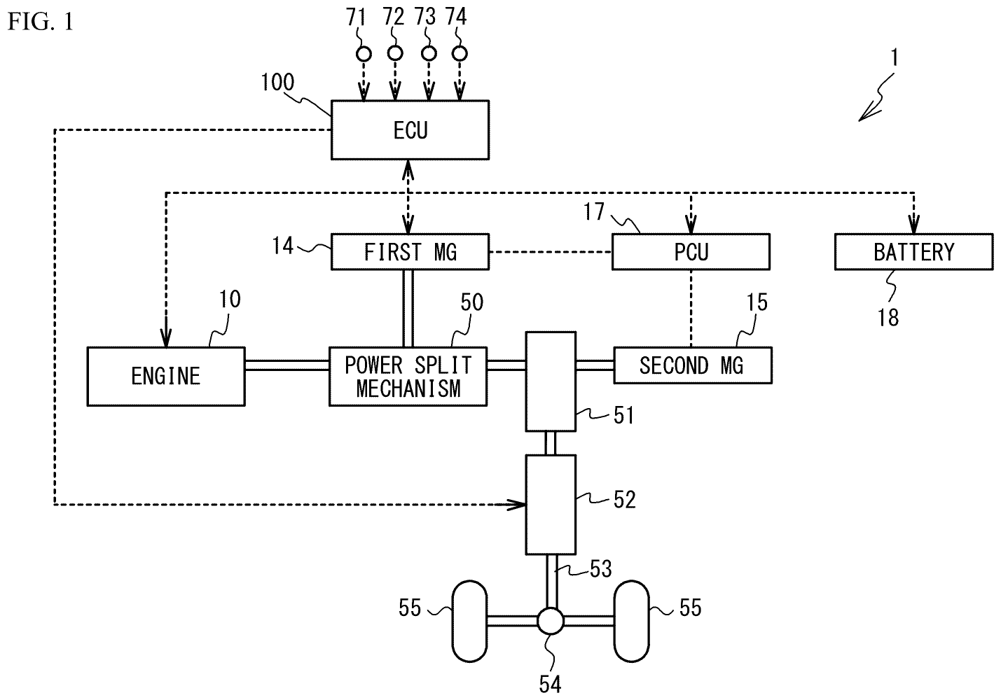

FIG. 1 is a schematic configuration view of a hybrid vehicle 1 according to the present embodiment. The hybrid vehicle 1 includes an electronic control unit (ECU) 100, an engine 10, a first motor generator (hereinafter referred to as a “first MG”) 14, a second motor generator (hereinafter referred to as a “second MG”) 15, a power control unit (PCU) 17, a battery 18, a power split mechanism 50, a transmission mechanism 51, a gearbox 52, a drive shaft 53, differentials 54, and drive wheels 55. The engine 10 has four cylinders #1 to #4 in the present embodiment. The number of cylinders is not limited to four as long as the engine 10 has a plurality of cylinders. The engine 10 is a gasoline engine, but is not limited thereto, and may be a diesel engine. The engine 10, the first MG 14, and the second MG 15 are power sources for traveling of the hybrid vehicle 1.

Each of the first MG 14 and the second MG 15 has a function as a motor that outputs torque by electric power supply and a function as a power generator that generates regenerative electric power by torque being applied. The first MG 14 and the second MG 15 are electrically connected to the battery 18 via the PCU 17. The PCU 17 supplies electric power from the battery 18 to the first MG 14 or the second MG 15. The PCU 17 causes the battery 18 to receive the regenerative electric power generated in the first MG 14 or the second MG 15.

The power split mechanism 50 mechanically couples a crankshaft of the engine 10, a rotation shaft of the first MG 14, and an output shaft of the power split mechanism 50. The output shaft of the power split mechanism 50 is coupled to the transmission mechanism 51. The rotation shaft of the second MG 15 is coupled to the transmission mechanism 51. The transmission mechanism 51 is connected to the gearbox 52. The gearbox 52 is connected to the drive shaft 53. The driving forces of the engine 10, the first MG 14, and the second MG 15 are transmitted to the drive wheels 55 via the transmission mechanism 51, the gearbox 52, the drive shaft 53, and the differentials 54.

The gearbox 52 is a stepped automatic shifting device provided between the second MG 15 and the drive shaft 53. The gearbox 52 changes the gear ratio by the control of the ECU 100.

The ECU 100 includes a processing circuit that performs various processing related to the traveling control of the automobile. The ECU 100 is an example of a control device of a hybrid vehicle. The ECU 100 functionally achieves a switching unit, a determination unit, and a setting unit, which will be described later.

An ignition switch 71, an accelerator opening sensor 72, a vehicle speed sensor 73, and a state of charge (SOC) sensor 74 are electrically connected to the ECU 100.

The ignition switch 71 detects an on/off state of an ignition. The accelerator opening sensor 72 detects an operation position of an accelerator pedal. The vehicle speed sensor 73 detects the vehicle speed of the hybrid vehicle 1. The SOC sensor 74 detects the charged amount of the battery 18.

When the required value related to the first MG 14 and the second MG 15 are less than a predetermined switching value, the ECU 100 switches a traveling mode of the hybrid vehicle 1 to the motor traveling mode. The motor traveling mode is a traveling mode in which at least one of the first MG 14 and the second MG 15 is used as a power source in a state where the engine 10 is stopped. In the motor traveling mode, the engine 10 is stopped. This improves fuel efficiency.

When the required value related to the first MG 14 and the second MG 15 is equal to or greater than the switching value, the ECU 100 switches the traveling mode to a hybrid traveling mode. The hybrid traveling mode is a traveling mode in which the engine 10 is driven and the engine 10 is used as a power source. The hybrid traveling mode also includes a case where at least one of the first MG 14 and the second MG 15 is used in combination with the engine 10. In the hybrid traveling mode, the engine 10 is driven. Therefore, the acceleration response is improved and the drivability is secured. The required value related to the first MG 14 and the second MG 15 is calculated by the ECU 100 based on the accelerator opening rate, the driving state, and the like. The required value related to the first MG 14 and the second MG 15 is, for example, an output power value required for the first MG 14 and the second MG 15, or a torque value required for the first MG 14 and the second MG 15. The switching of the traveling mode is an example of a process executed by the switching unit.

The ECU 100 switches the driving mode of the hybrid vehicle 1 to the autonomous driving mode or the manual driving mode. The autonomous driving mode is a driving mode in which the hybrid vehicle 1 autonomously travels by automatic driving. The manual driving mode is a driving mode in which the vehicle travels in accordance with a manual operation of the driver. In the manual driving mode, the driver performs steering, acceleration, and deceleration operations. The switching of the driving mode may be performed by the ECU 100 in response to an operation of the driver, or may be automatically performed by the ECU 100.

### Switching Value Setting Control

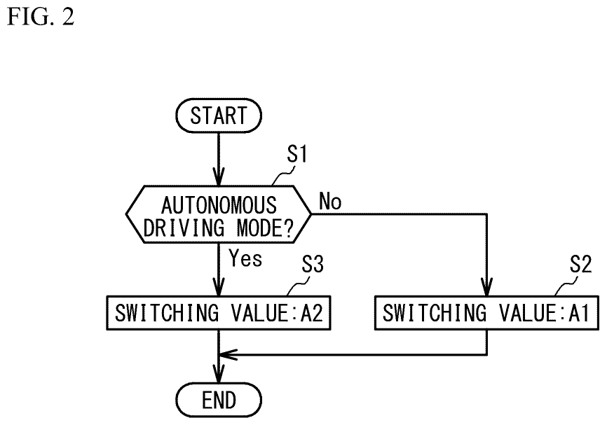

FIG. 2 is a flowchart illustrating an example of switching value setting control. This control is repeatedly executed at predetermined intervals in a state where the ignition is on. The ECU 100 determines whether or not the driving mode is the autonomous driving mode (step S1). When the driving mode is the manual driving mode, the determination result in step S1 is No. Step S1 is an example of a process executed by the determination unit.

If the determination result is No in step S1, the ECU 100 sets the switching value to a value A1 (step S2). If the determination result is Yes in step S1, the ECU 100 sets the switching value to a value A2 (step S3). The value A2 is greater than the value A1. Steps S2 and S3 are examples of processes executed by the setting unit.

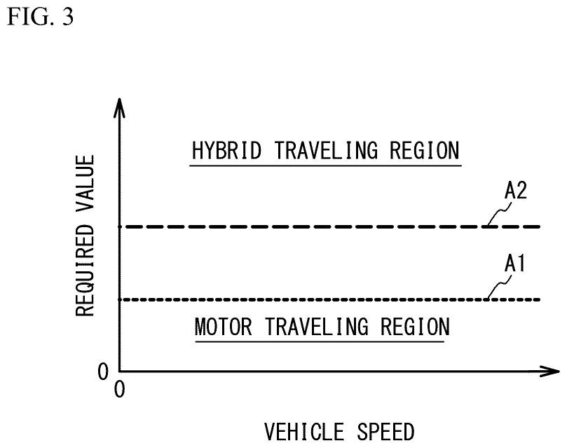

FIG. 3 is an exemplary view of a map defining the switching value. In the map of FIG. 3, the vertical axis represents the above-described required value, and the horizontal axis represents the vehicle speed. In the example of FIG. 3, both of the values A1 and A2 are fixed values that do not change depending on the vehicle speed. When the driving mode is the manual driving mode and the required value is less than the value A1, the traveling mode is switched to the motor traveling mode. When the driving mode is the manual driving mode and the required value is equal to or greater than the value A1, the traveling mode is switched to the hybrid traveling mode. When the driving mode is the autonomous driving mode and the required value is less than the value A2, the traveling mode is switched to the motor traveling mode. When the driving mode is the autonomous driving mode and the required value is equal to or greater than the value A2, the traveling mode is switched to the hybrid traveling mode.

In this way, in the manual driving mode, a hybrid traveling region is larger and a motor traveling region is smaller than in the autonomous driving mode. Therefore, the frequency of switching to the hybrid traveling mode is secured in the manual driving mode. Therefore, drivability in the manual driving mode is secured. In the autonomous driving mode, the motor traveling region is larger and the hybrid traveling region is smaller than in the manual driving mode. Therefore, the frequency of switching to the motor traveling mode is secured in the autonomous driving mode.

Therefore, fuel efficiency in the autonomous driving mode is improved. Thus, the drivability is secured and the fuel consumption is improved.

As described above, the value A1 is a fixed value that does not change depending on the vehicle speed. Therefore, the drivability is secured in a wide speed range regardless of the vehicle speed.

### Variation

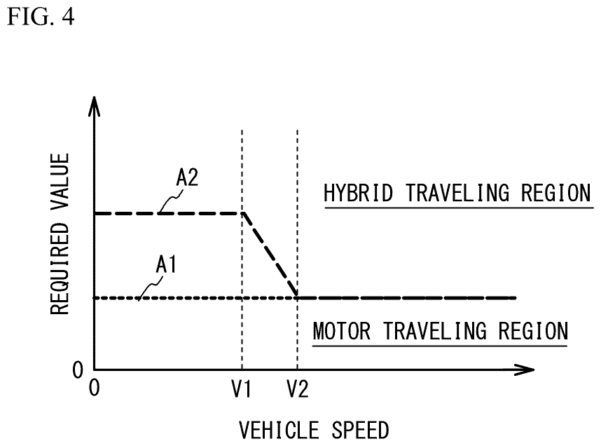

FIG. 4 is a first variation of a map illustrating the switching value. As illustrated in FIG. 4, in the first variation, the value A2 is a variable value corresponding to the vehicle speed. The value A2 is defined to increase as the vehicle speed decreases. In detail, when the vehicle speed is less than the speed V1, the value A2 is constant. When the vehicle speed is equal to or higher than the speed V1 and lower than the speed V2, the value A2 increases as the vehicle speed decreases. When the vehicle speed is equal to or higher than the speed V2, the value A2 is constant. In this way, the motor traveling region is secured when the vehicle speed in the autonomous driving mode is low. The fuel efficiency of the engine 10 is lower in the low speed range than in the high speed range. In this way, the motor traveling region is secured in the low speed range where the fuel efficiency of the engine 10 is poor. This improves the fuel efficiency.

The value A2 is not limited to being constant in the case where the vehicle speed is less than the speed V1 and in the case where the vehicle speed is equal to or higher than the speed V2. The value A2 may increase stepwise or continuously as the vehicle speed decreases. The value A2 is not limited to being the same as the value A1 when the vehicle speed is equal to or higher than speed V2. The value A2 may be greater than the value A1 when the vehicle speed is equal to or higher than the speed V2.

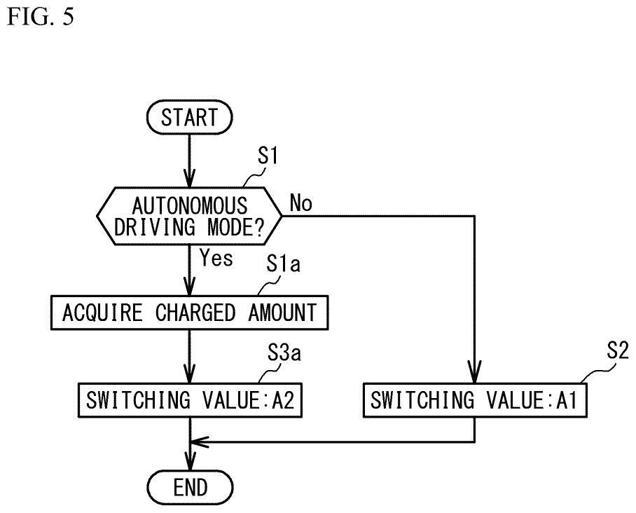

FIG. 5 is a flowchart of a variation of the switching value setting control. In the present variation, the ECU 100 functionally achieves an acquiring unit in addition to the switching unit, the determination unit, and the setting unit described above. If the determination result is Yes in step S1, the ECU 100 acquires a charged amount of the battery 18 based on a detected value of the SOC sensor 74 (step S1a). The battery 18 is a power source for the first MG 14 and the second MG 15. Step S1a is an example of a process executed by the acquiring unit.

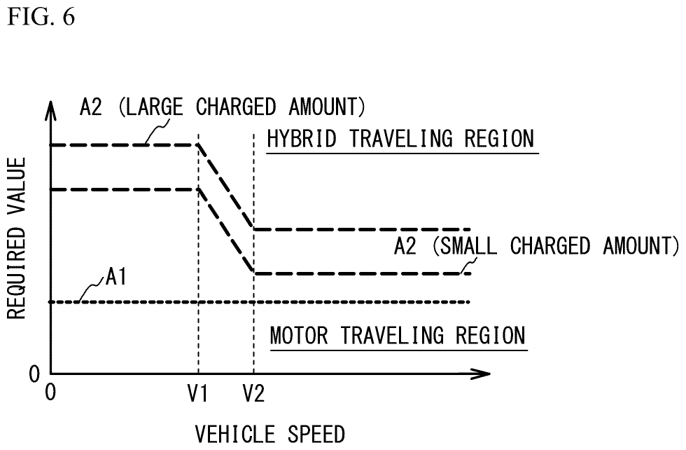

Next, the ECU 100 sets the switching value to the value A2 (step S3a). The value A2 is defined to increase as the charged amount of the battery 18 increases. FIG. 6 is a second variation of a map illustrating the switching value. FIG. 6 illustrates the value A2 in the case where the charged amount is large and the value A2 in the case where the charged amount is small. The value A2 in the case where the charging amount is large is larger than the value A2 in the case where the charging amount is small. Thus, the motor traveling region in the autonomous driving mode is expanded as the charged amount of the battery 18 is increased. Therefore, the fuel efficiency is improved in accordance with the charged amount of the battery 18. The motor traveling region in the autonomous driving mode is reduced as the charged amount of the battery 18 is decreased. As a result, the battery 18 is prevented from being over-discharged.

In the example of FIG. 6, the value A2 is a variable value that changes in accordance with the vehicle speed. However, the value A2 may be a fixed value that does not change in accordance with the vehicle speed. The value A1 is not limited to a fixed value. The switching value may be calculated by an arithmetic expression using the required value and the vehicle speed as arguments.

Although some embodiments of the present disclosure have been described in detail, the present disclosure is not limited to the specific embodiments but may be varied or changed within the scope of the present disclosure as claimed.

What is claimed is:

1. A control device for a hybrid vehicle including a motor and an engine, the control device comprising:
a switching unit configured to switch a traveling mode of the hybrid vehicle to a motor traveling mode in which the engine is stopped and the motor is driven when a required value related to the motor is less than a switching value, and to switch the traveling mode to a hybrid traveling mode in which the engine is driven when the required value is equal to or greater than the switching value;
a determination unit configured to determine whether a driving mode of the hybrid vehicle is an autonomous driving mode or a manual driving mode; and
a setting unit configured to set the switching value to a first value when the driving mode is the manual driving mode, and to set the switching value to a second value greater than the first value when the driving mode is the autonomous driving mode.

2. The control device for the hybrid vehicle according to claim 1, wherein the second value increases as a vehicle speed of the hybrid vehicle decreases.

3. The control device for the hybrid vehicle according to claim 2, wherein the first value is a fixed value that does not change depending on the vehicle speed.

4. The control device for a hybrid vehicle according to claim 1, further comprising an acquisition unit configured to acquire a charged amount of a battery that is a power source of the motor,
wherein the second value increases as the charged amount of the battery increases.
